(19) United States
(12) Patent Application Publication
(10) Pub. No.: US 2002/0136218 A1
(43) Pub. Date: Sep. 26, 2002

(54) Method and apparatus for receiving interleaved streams of packets through a circular buffer

(76) Inventor: Augusto C. Cardoso JR., Oakland, CA (US)

Correspondence Address: PARK, VAUGHAN & FLEMING LLP, 508 SECOND STREET, SUITE 201, DAVIS, CA, 95616, US

(21) Appl. No.: 09/816,709

(22) Filed: Mar. 23, 2001

(51) Int. Cl. H04L 12/56

(52) U.S. Cl. 370/394; 370/474

(57) ABSTRACT

One embodiment of the present invention provides a system that reassembles multiple streams of Internet Protocol (IP) packets that have been converted into a single interleaved stream of transport protocol packets. Upon receiving the stream of the transport packets, the system reassembles the IP packets within a single IP packet buffer. At the same time, the system keeps track of the order in which reassembly is completed for the IP packets. This enables the system to read the IP packets out of the single IP packet buffer in the order in which reassembly is completed before forwarding the reassembled IP packets to destinations specified by IP addresses contained in the IP packets. Note that reading the IP packets out of the IP packet buffer in this order can minimize the latency for individual streams of IP packets because a given IP packet that is completed first does not have to wait for a previously started IP packet that has not been completed. Furthermore, using a single buffer for reassembling the multiple streams of IP packets greatly reduces the amount of memory required to assemble the IP packets.

### BACKGROUND

1. Field of the Invention

The present invention relates to computer systems and data transmissions. More specifically, the present invention relates to a method and an apparatus for receiving multiple streams of packets that are interleaved together into a single stream through a circular buffer.

2. Related Art

Internet users are presently demanding more bandwidth than can be provided with a conventional modem connection through a telephone line. The 56K data transfer rate provided by a conventional modem connection is not sufficient to rapidly transfer graphical images that are commonly incorporated into web sites. Hence, people browsing through web pages within websites are continually waiting for images to load. Furthermore, other data-intensive services, such as high quality streaming video, are essentially impossible to provide through a 56K modem connection.

People are presently developing a number of alternatives to the standard 56K modem. DSL modems can provide high data transfer rates through existing telephone lines, but they require expensive modifications to the switching equipment inside telephone company central offices. Hence, DSL technology cannot be used without a major investment by the local telephone system, and some local telephone systems have been hesitant to make such an investment. Furthermore, in many cases a DSL modem cannot achieve a high data transfer rate if the telephone line to the telephone system central office is too long, or if the telephone line has poor quality wiring.

Cable modems can also provide high data transfer rates, but providing modem access through a cable network requires a significant investment in new equipment by a local cable company, and some local cable companies have been hesitant to make such an investment. Furthermore, some regions are not yet wired for cable.

Another option is to use satellite communications channels to provide high data transfer rates. Unlike DSL modems or cable modems, satellite communication channels are not under the control of local utility providers.

However, using satellite communication channels poses other challenges. In order for satellite-based systems to be successful, low-cost, high-performance receiving stations must be developed to receive the satellite transmissions. More specifically, a system must be developed to convert a stream of transport packets, such as a Motion Picture Experts Group (MPEG) 2 transport stream, into a form that is suitable for transmission over a local computer network, such as IP packets.

One challenge in developing such a system is to minimize the amount of circuitry required to convert transport packets into IP packets, and to thereby minimize the total cost of the satellite receiving system. One way to reduce the amount of circuitry is to use special-purpose hardware to perform the conversion instead of using a larger general-purpose microprocessor.

The amount of circuitry can be further reduced by minimizing the amount of memory required to reconstruct the IP packets. This memory reduction is complicated by the fact that the stream of transport packets may include multiple streams of IP packets that are interleaved together into the single stream of transport packets. Hence, multiple IP packets from different streams may have to be assembled at the same time. This can be accomplished by maintaining a separate queue for each stream of IP packets. However, maintaining separate queues can consume a great deal of memory, because each queue has to be large enough to accommodate a worst case demand for the associated stream, and there can be many streams.

What is needed is a method and an apparatus for reducing the amount of memory required to reconstruct multiple streams of IP packets from a single interleaved stream of transport packets.

### SUMMARY

One embodiment of the present invention provides a system that reassembles multiple streams of Internet Protocol (IP) packets that have been converted into a single interleaved stream of transport protocol packets. Upon receiving the stream of the transport packets, the system reassembles the IP packets within a single IP packet buffer. At the same time, the system keeps track of the order in which reassembly is completed for the IP packets. This enables the system to read the IP packets out of the single IP packet buffer in the order in which reassembly is completed before forwarding the reassembled IP packets to destinations specified by IP addresses contained in the IP packets. Note that reading the IP packets out of the IP packet buffer in this order can minimize the latency for individual streams of IP packets because a given IP packet that is completed first does not have to wait for a previously started IP packet that has not been completed. Furthermore, using a single buffer for reassembling the multiple streams of IP packets greatly reduces the amount of memory required to assemble the IP packets.

In one embodiment of the present invention, keeping track of the order in which reassembly is completed involves maintaining a circular buffer containing pointers to completed IP packets within the single IP packet buffer. In this embodiment, a pointer to a completed IP packet is entered into the circular buffer upon completion of the IP packet.

In one embodiment of the present invention, reading the IP packets out of the single IP packet buffer involves advancing a buffer pointer around the circular buffer containing pointers to completed IP packets. The system then reads the completed IP packets through pointers that are pointed to by the buffer pointer, so that the completed IP packets are read out of the single IP packet buffer in the order in which they were completed.

In one embodiment of the present invention, the single IP packet buffer is organized as a circular buffer, wherein buffers for incoming IP packets are appended to the end of the circular buffer.

In one embodiment of the present invention, reassembling the IP packets from the transport packets involves maintaining a write pointer into the single IP packet buffer for each stream of IP packets, wherein each write pointer points to a packet being reassembled for an associated stream of IP packets. In a variation on this embodiment, each write pointer includes a start pointer that points to the start of a packet being received for the associated stream within the single IP packet buffer. It also includes a number of bytes received so far for the packet being received, and logic that calculates the write pointer from the start pointer and the number of bytes received so far.

In one embodiment of the present invention, upon receiving a single transport packet that includes an end section of a first IP packet and a beginning section of a second IP packet, the system directs the end section of the first IP packet to a first location in the single IP packet buffer wherein the first IP packet is being reassembled. The system also directs the beginning section of the second IP packet to a second location in the single IP packet buffer where the second IP packet is being reassembled.

In one embodiment of the present invention, the single stream of transport packets includes MPEG2 transport packets.

In one embodiment of the present invention, reassembling IP packets involves filtering transport packets based upon packet identifiers (PIDs) to filter out transport packets containing data that is not of a specified type for the IP packets.

In one embodiment of the present invention, reassembling IP packets involves checking continuity for transport packets to ensure that all transport packets that make up an IP packet are received in sequential order.

In one embodiment of the present invention, the system additionally filters the IP packets based upon media access control (MAC) addresses to filter out IP packets that are not directed to an IP destination address on a local network.

In one embodiment of the present invention, the single stream of transport packets is received from a satellite.

### BRIEF DESCRIPTION OF THE FIGURES

FIG. 1 illustrates a system for communicating a data stream from a satellite to a computer network in accordance with an embodiment of the present invention.

FIG. 2 illustrates the internal structure of an interface module that converts satellite transmissions into IP packets in accordance with an embodiment of the present invention.

FIG. 3 illustrates the internal structure of a multi-IP receiver in accordance with an embodiment of the present invention.

FIG. 4 illustrates how multiple streams of IP packets are converted into transport packets and interleaved together.

FIG. 5 illustrates data storage elements involved in the packet reconstruction process in accordance with an embodiment of the present invention.

FIG. 6 illustrates operation of the circular buffer for IP packets in accordance with an embodiment of the present invention.

FIG. 7 is a flow chart illustrating the process of reconstructing IP packets from transport packets in accordance with an embodiment of the present invention.

FIG. 8 is a flow chart illustrating the process of reading IP packets from the IP packet buffer in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Communication System

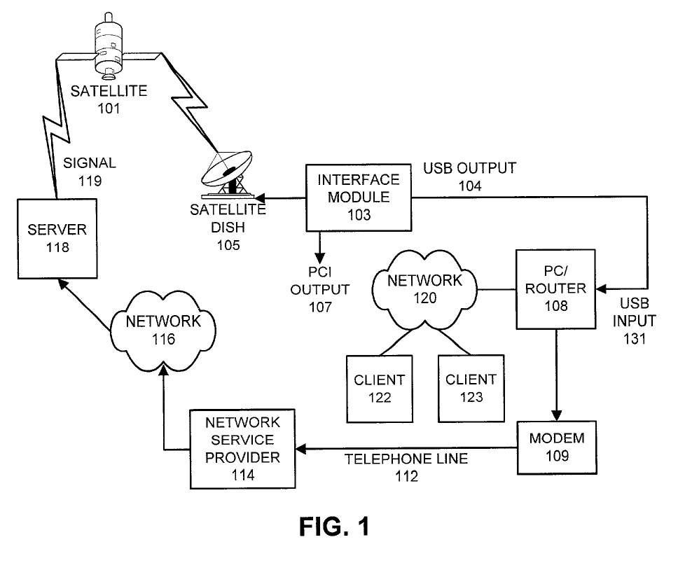

FIG. 1 illustrates a system for communicating a data stream from a satellite 101 to a network 120 in accordance with an embodiment of the present invention. Satellite 101 can include any type of broadcast satellite or communication satellite that is capable of sending a transport stream, such as a digital MPEG2 transport stream. Server 118 transmits a signal 119 to satellite 101. Server 118 can include any computational node including a mechanism for servicing requests from a client for computational or data storage resources. In one embodiment, server 118 is a web server that hosts a web site. Not shown in FIG. 1 is the circuitry for converting an output from server 118 into a signal 119 suitable for transmission to satellite 101. Signal 119 is forwarded from satellite 101 to satellite dish 105, which is coupled with interface module 103.

Interface module 103 converts the signal from satellite 101 into a digital form that can be manipulated by the computer system. Interface module 103 produces two different types of output. The first output is a Peripheral Component Interface (PCI) output 107, which enables interface module 103 to communicate directly with a computer system through a PCI bus. The second output is universal serial bus (USB) output 104, which provides a serial interface between interface module 103 and PC/router 108. PC/router 108 can include any type of system, such as a personal computer, a hub or a router, that can be used to facilitate communications across a network.

In FIG. 1, PC/router 108 is coupled to clients 122-123 through network 120. Network 120 can include any type of wire or wireless communication channel capable of coupling together computing nodes. This includes, but is not limited to, a local area network, a wide area network, or a combination of networks. In one embodiment of the present invention, network 120 includes the Internet. In the embodiment illustrated in FIG. 1, network 120 is a local area network. Clients 122 and 123 can include any node on network 120 including computational capability and including a mechanism for communicating across network 120.

PC/router 108 is also coupled to modem 109, which provides a low-to-mid-bandwidth communication path to server 118. More specifically, PC/router 108 communicates with network service provider 114 through modem 109 and telephone line 112. Network service provider 114 communicates with server 118 through network 120. Network service provider 114 can include any type of mechanism for linking modem 109 with network 116 through telephone line 112. Note that instead of using modem 109 and telephone line 112, the system can alternatively use any other type of communication pathway to server 118. For example, the system can use an ISDN linkage, a DSL linkage, a wireless communication channel, or a satellite communication channel.

Network 116 can include any type of wire or wireless communication channel capable of coupling together computing nodes. This includes, but is not limited to, a local area network, a wide area network, or a combination of networks. In one embodiment, network 116 includes the Internet. In one embodiment, network 116 and network 120 are the same network.

The system illustrated in FIG. 1 operates generally as follows. Clients 122-123 communicate with server 118 through a high-bandwidth pathway through satellite 101 and a low-to-mid-bandwidth pathway through modem 109. The high-bandwidth pathway is used to transfer data, such as graphical images from server 118 to clients 122-123. The low-to-mid-bandwidth pathway is used to transfer commands and other input from clients 122-123 to server 118. This type of asymmetric arrangement is well-suited for applications such as web sites that send large volumes of data (such as graphical images) to clients, and yet receive only a small amount of data from the clients.

Using the high-bandwidth pathway, server 118 sends signal 119 through satellite 101 into interface module 103. Interface module 103 converts this signal into IP packets within USB frames and sends the USB frames to PC/router 108. PC/router 108 extracts the IP packets from the USB frames and sends the IP packets across network 120 to clients 122-123.

Using the low-to-mid-bandwidth pathway, clients 122-123 send data across network 120 to PC/router 108. PC/router 108 forwards the data to network service provider 114 through modem 109. Network service provider 114 forwards the data across network 116 to server 118.

Interface Module

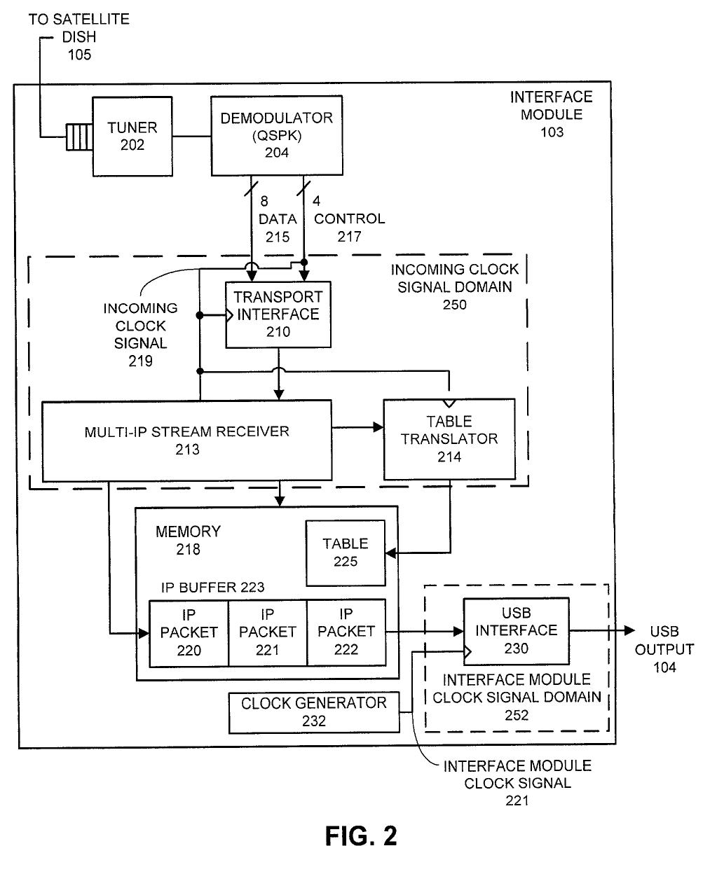

FIG. 2 illustrates the internal structure of an interface module 103 that converts satellite transmissions into IP packets in accordance with an embodiment of the present invention. Interface module 103 includes tuner 202 and demodulator 204. Tuner 202 can include any type of circuit that can be tuned to receive signals from a satellite (or any other high-bandwidth MPEG2 data stream). Demodulator 204 can include any type of circuit that can demodulate signals received from a satellite through tuner 202. Demodulator 204 converts the signal received from satellite 101 into a digital form, which is transferred across data lines 215 and control lines 217 into transport interface 210.

Transport interface 210 includes circuitry for receiving data lines 215 and control lines 217. Note that control lines 217 include incoming clock signal 219, which is part of the transport stream. In one embodiment of the present invention, transport interface 210 is an MPEG2 transport interface for receiving MPEG2 transport signals.

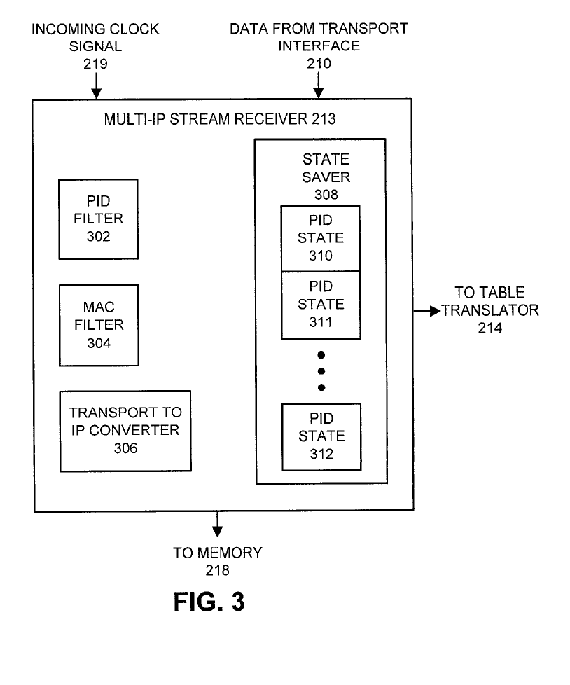

Transport interface 210 forwards signals through multi-IP stream receiver 213. Multi-IP stream receiver 213 contains circuitry that filters transport packets based upon packet type as specified in a packet identifier (PID). Some packets, such as NULL packets, are discarded by a PID filter 302 within multi-IP stream receiver 213 (see FIG. 3). Other packets are routed in different directions. For example, transport packets containing audio and video data are routed directly into memory 218. Transport packets containing tabular data are routed through table translator 214 to produce tables, such as table 225 within memory 218. Transport packets containing IP packets are routed through transport-to-IP converter 306 within multi-IP stream receiver 213 (see FIG. 3), which converts transport packets into IP packets and stores the IP packets into IP buffer 223 for reassembling packets 220-222 within memory 218.

Next, IP packets 220-222 are retrieved by USB interface 230 and are forwarded through USB output 104. Note that USB interface 230 operates under control of interface module clock signal 221, which is locally generated within interface module 103 by clock generator 232. Hence, USB interface 230 operates within the clock domain 252 of interface module clock signal 221.

In contrast, components that write IP packets into IP buffer 223, including transport interface 210, transport-to-IP converter 306, PID filter 302 and table translator 214, all operate under control of incoming clock signal 219, which is received from demodulator 204 along with the transport stream. Hence, transport interface 210, transport-to-IP converter 306, PID filter 302 and table translator 214 all operate within incoming clock signal domain 250.

Note that interface module 103 does not include a general-purpose microprocessor for converting transport packets into IP packets, but instead includes special-purpose hardware, including state machines, to perform the conversion. Using special-purpose hardware requires far less circuitry and resources than using a general-purpose microprocessor.

Multi-IP Receiver

FIG. 3 illustrates the internal structure of multi-IP stream receiver 213 in accordance with an embodiment of the present invention. As mentioned above with reference to FIG. 2, multi-IP stream receiver 213 includes PID filter 302, which filters transport packets based upon packet type, as well as transport-to-IP converter 306, which converts transport packets into IP packets.

Multi-IP stream receiver 213 also includes media access control (MAC) filter 304, which is configured to filter IP packets based upon MAC addresses in order to filter out IP packets that are not directed to an IP destination address on local network 120.

Multi-IP stream receiver 213 additionally includes state sever 308, which saves the state of current packet translations for each PID in the interleaved transport stream. For example, state saver 308 includes PID state 310, PID state 311 and PID state 312 for each different PID that may be included in the interleaved transport stream from transport interface 210.

Interleaving of Transport Packets

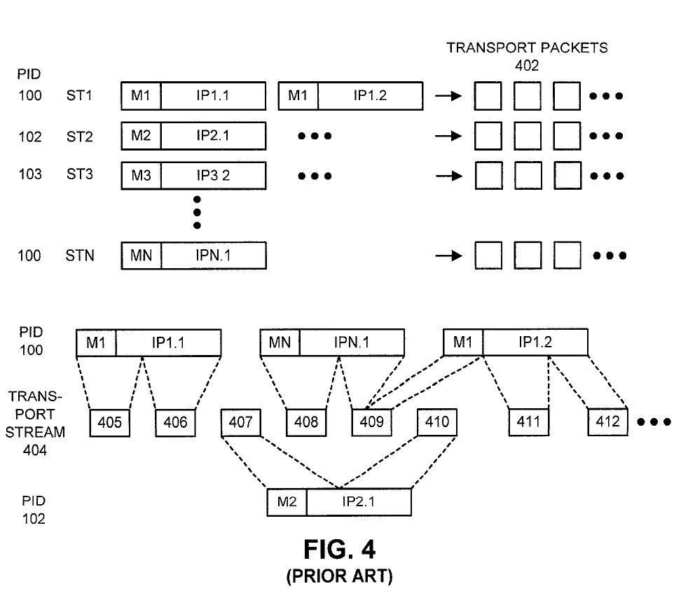

FIG. 4 illustrates how multiple streams of IP packets are converted into transport packets and interleaved together to form transport stream 404, which is received from satellite 101.

As illustrated in the top portion of FIG. 4, a number of different streams ST1, ST2, ST3, . . . , STN, which are associated with MAC addresses M1, M2, M3, . . . , MN, are converted into PID steams, which are then converted into transport packets. Note that multiple MAC address streams may be associated with a single PID stream. For example, both stream ST1 and STN are associated with PID 100. Hence, the stream for PID 100 includes IP packets from both ST1 and STN. (See the middle section of FIG. 4 which illustrates a packet for ST1 containing IP1.1, followed by a packet for STN, containing IPN.1, followed by a packet for STN, containing IPN.2.)

Each PID stream is divided into transport packets, and these transport packets from the individual PID streams are interleaved together to produce the single transport stream. For example, in the bottom portion of FIG. 4 packet IP1.1 is divided into transport packets 405 and 406; packet IPN.1 is divided into transport packets 408 and 409; packet IP1.2 is divided into transport packets 409, 411 and 412; and packet IP2.1 is divided into transport packets 407 and 410.

Note that the end portion of packet IPN1 and the beginning portion of packet IP2.1 are contained within the same transport packet 409. This is called “section packing”. Also note that transport-to-IP converter 306 performs the reverse operation, which is known as “section unpacking”.

In the example illustrated in FIG. 4, transport packets from PID stream 102 are interleaved within transport packets from PID stream 100. Transport-to-IP converter 306 undoes this interleaving in order to reconstruct the IP packets.

Data Storage Elements

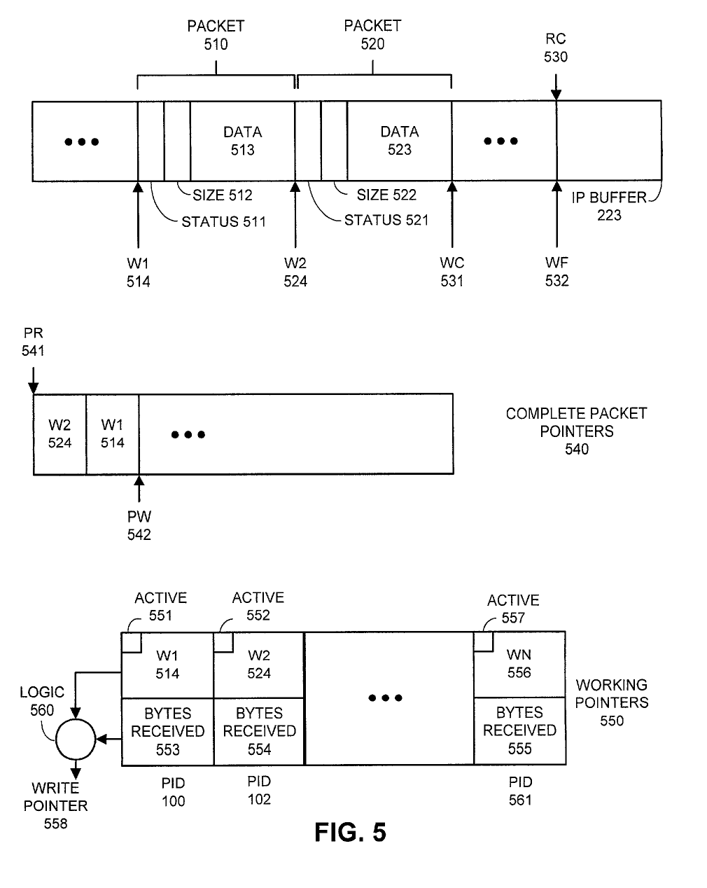

FIG. 5 illustrates data storage elements involved in the packet reconstruction process in accordance with an embodiment of the present invention. These data storage elements include IP buffer 223, complete IP packet pointers 540 and working pointers 550.

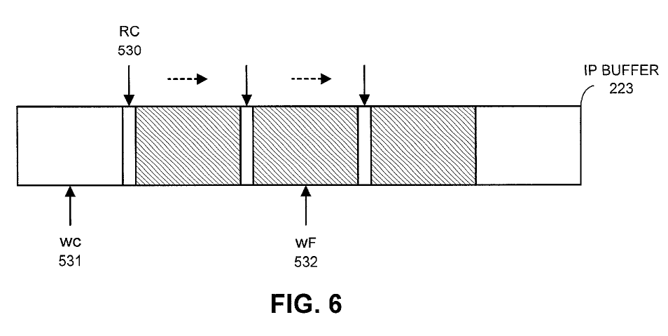

IP buffer 223 is organized as a circular buffer with a read current (RC) pointer 530, a write current (WC) 531 and a write future (WF) pointer 532. The operation of these pointers is described in more detail with reference to FIG. 6 below.

IP packets from multiple streams are reassembled within IP buffer 223. For example, IP packet 510 for PID 100 is being reassembled at the same time as IP packet 520 for PID 102 is being reassembled. Note that IP packet 510 includes a status indicator 511 as well as a packet size 512. Status indicator 511 can be in one of three states, “working”, “complete”, or “done”. “Working” indicates that the packet is presently being reassembled. “Complete” indicates that reassembly for the packet is complete, and the packet is waiting to be forwarded to its ultimate destination. “Done” indicates that the packet has been forwarded to its ultimate destination. The system examines packet size 512 in order to allocate sufficient space within IP buffer 223 for IP packet 510. Note that IP packet 520 similarly contains status 521 and size 522.

Complete packet pointers 540 is a circular buffer containing packets that have been completed within IP buffer 223 and are waiting to the read out of IP buffer 223 in order to be forwarded to their ultimate destination. This circular buffer includes a pointer for reading (PR) 541 and a pointer for writing (PW) 542. PR 541 indicates which packet is to be read out of IP buffer 223 next, and PW 542 indicates a location within the circular buffer to be written to next. If PR 541 equals PW 542, there are no complete packets to be read out of IP buffer 223.

Note that pointers are stored into the circular buffer in the order in which they are completed. Hence, a packet that is completed first within IP buffer 223 will be read out of IP buffer 223 before a packet that was started first but completed later.

Working pointers 550 includes an entry for each PID. Each entry includes a pointer to the beginning of the associated packet within IP packet buffer 223, as well as the number of bytes received so far and an active flag, which indicates whether the entry is active. For example, the entry for PID 100 includes pointer W1 514, which points to the start of IP packet 510 in IP buffer 223 as well as a number of bytes received 553. Logic 560, which is permanently attached to each working pointer, produces write pointer 558, which is used to write data to the associated packet in IP packet buffer 223. Note that PID 102 similarly has a pointer W2 524 and a number of bytes received 554. Moreover, PID 561 also has a pointer WN 556 and a number of bytes received 555.

Circular Buffer Operation

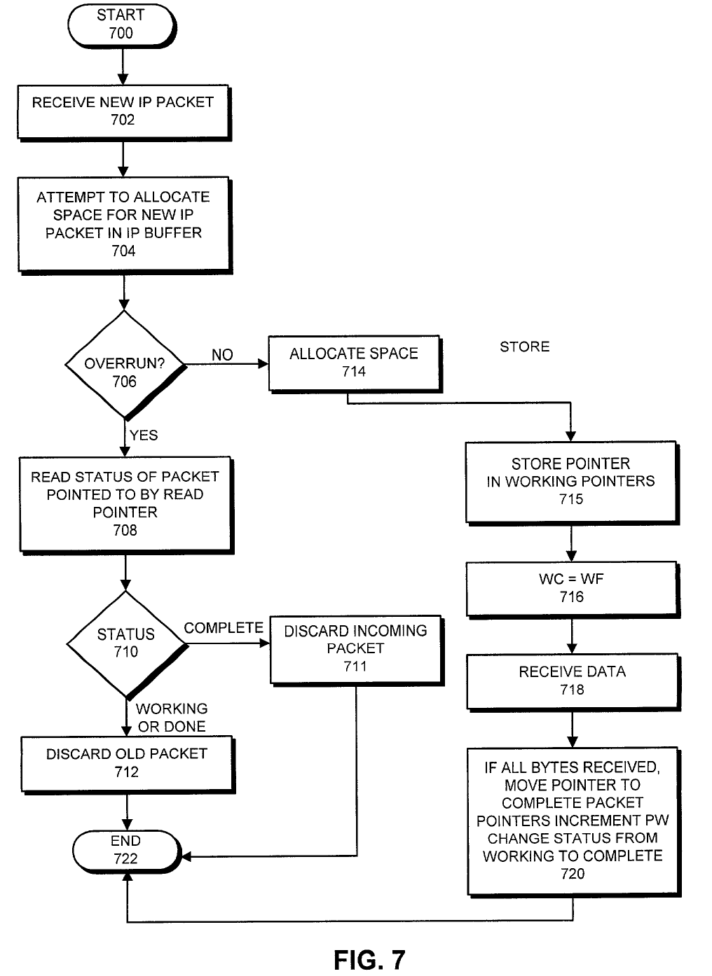

FIG. 6 illustrates operation of the circular buffer for IP packets 223 in accordance with an embodiment of the present invention. When a first section of new IP packet is received as part of a transport packet, the packet size contained int the IP packet header is used to determine how much space is to be allocated for the packet. This is done by adding the packet size to WC 531 to produce WF 532. If WF 532 exceeds read pointer RC 530, an overflow condition may arise. This is described in more detail with reference to FIG. 7 below.

Process of Reconstructing IP Packets

FIG. 7 is a flow chart illustrating the process of reconstructing IP packets from transport packets in accordance with an embodiment of the present invention. The system starts by receiving a beginning section of a new IP packet as part of a transport packet (step 702). The system first attempts to allocate additional space for the new IP packet within IP buffer 223 by adding the packet size to WC 531 to calculate a new WF 532 (step 704).

The system next determines if an overflow exists by testing to see of WF 532 has passed RC 530 within the circular IP buffer 223 (step 706).

If an overflow exists, the system reads the status of the packet pointed to by RC 530 (step 708). If the status is “done” or “working”, the old packet pointed to by RC 530 is discarded (step 712). This assumes that a packet that has a “working” status and has not been completed is missing a section and will never be completed unless a retry takes place. If the status is “complete”, RC 530 points to a complete packet that is waiting to be forwarded. In this case, the incoming packet is discarded (step 711).

If at step 706, an overflow condition does not exist, normal packet processing takes place. Space for the new packet is first allocated within IP buffer 223 (step 714). A pointer to this new packet is then stored for the associated PID within working pointers 550 (step 715). Also, WC 513 is advanced by setting to WF 532 (step 716).

Finally, the data for the new packet is received in subsequent transport packets (step 718). If all bytes are received, the pointer for the packet is moved to the next location in circular order (which is pointer to by PW 542) within complete packet pointers 540, and PW 542 is incremented. The status field of the packet within IP buffer 223 is also changed to complete (step 720).

Process of Reading out IP Packets

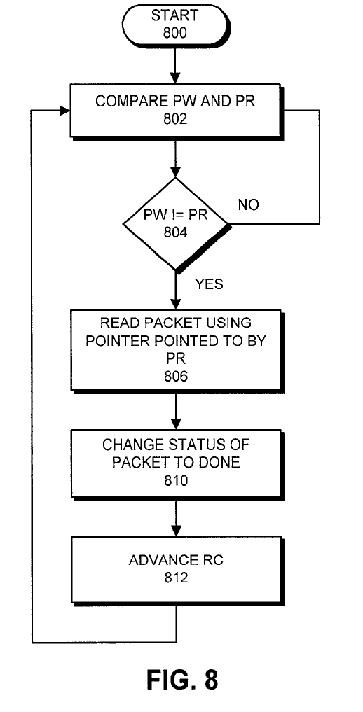

FIG. 8 is a flow chart illustrating the process of reading IP packets from IP packet buffer 223 in accordance with an embodiment of the present invention. The system continually compares PW 542 and PR 541 (step 802). If PW 542 equals PR 541, then the system returns to state 802 to compare again.

If PW 542 does not equal PR 541, then there are complete packets waiting to be read out of IP buffer 223. In this case the system reads the next packet within the circular buffer containing complete pointers 540. This packet is pointed to by PR 541 (step 806). Next, the system changes the status of the packet within IP buffer 223 to “done” (step 810). Finally, the system advances RC 514 to point to the next entry in complete packet pointers 540 (step 812). In this way, IP packets are read out of IP buffer 223 in the order in which they are completed.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for receiving multiple streams of Internet Protocol (IP) packets that are interleaved together into a single stream of transport packets, comprising:
receiving the single stream of transport packets, wherein the single stream of transport packets includes multiple streams of IP packets that converted into transport protocol packets and are then interleaved together into the single stream of transport packets;
using the single stream of transport packets to reassemble IP packets for the multiple streams of IP packets within a single IP packet buffer;
keeping track of the order in which reassembly is completed for IP packets within the single IP packet buffer;
reading the IP packets out of the single IP packet buffer in the order in which reassembly is completed; and
forwarding the reassembled IP packets to their destinations as specified by IP addresses contained in the IP packets.

2. The method of claim 1, wherein keeping track of the order in which reassembly is completed involves maintaining a circular buffer containing pointers to completed IP packets in the single IP packet buffer, wherein a pointer to a completed IP packet is entered into the circular buffer upon completion of the IP packet.

3. The method of claim 2, wherein reading the IP packets out of the single IP packet buffer in the order in which packets are completed involves:
advancing a buffer pointer around the circular buffer containing pointers to completed IP packets; and
reading the completed IP packets through pointers that are pointed to by the buffer pointer;
whereby the completed IP packets are read out of the single IP packet buffer in the order in which they were completed.

4. The method of claim 1, wherein the single IP packet buffer is organized as a circular buffer, wherein buffers for incoming IP packets are appended to the end of the circular buffer.

5. The method of claim 1, wherein reassembling the IP packets from the transport packets involves maintaining a write pointer into the single IP packet buffer for each stream of IP packets, wherein each write pointer points to a packet being reassembled for an associated stream of IP packets.

6. The method of claim 5, wherein each write pointer includes:
a start pointer that points to the start of a packet being received for the associated stream within the single IP packet buffer;
a number of bytes received so far for the packet being received; and
logic that calculates the write pointer from the start pointer and the number of bytes received so far.

7. The method of claim 1, wherein using the single stream of transport packets to reassemble IP packets involves:
receiving a single transport packet that includes an end section of a first IP packet and a beginning section of a second IP packet;
directing the end section of the first IP packet to a first location in the single IP packet buffer where the first IP packet is being reassembled; and
directing the beginning section of the second IP packet to a second location in the single IP packet buffer where the second IP packet is being reassembled.

8. The method of claim 1, wherein the single stream of transport packets includes MPEG2 transport packets.

9. The method of claim 1, wherein reassembling IP packets involves filtering transport packets based upon packet identifiers (PIDs) to filter out transport packets containing data that is not of a specified type for the IP packets.

10. The method of claim 1, wherein reassembling IP packets involves checking continuity for transport packets to ensure that all transport packets that make up an IP packet are received in sequential order.

11. The method of claim 1, further comprising, filtering IP packets based upon media access control (MAC) addresses to filter out IP packets that are not directed to an IP destination address on a local network.

12. The method of claim 1, wherein the single stream of transport packets is received from a satellite.

13. An apparatus that is configured to receive multiple streams of Internet Protocol (IP) packets that are interleaved together into a single stream of transport packets, comprising:
a receiver that is configured to receive the single stream of transport packets, wherein the single stream of transport packets includes multiple streams of IP packets that converted into transport protocol packets and are then interleaved together into the single stream of transport packets;
a single IP packet buffer in which IP packets are reassembled;
a reassembly mechanism that is configured to reassemble IP packets for the multiple streams of IP packets from the single stream of transport packets;
an ordering mechanism that is configured to keep track of the order in which reassembly is completed for IP packets within the single IP packet buffer;
a reading mechanism that is configured to read the IP packets out of the single IP packet buffer in the order in which reassembly is completed; and
a forwarding mechanism that is configured to forward the reassembled IP packets to their destinations as specified by IP addresses contained in the IP packets.

14. The apparatus of claim 13,
wherein the ordering mechanism includes a circular buffer containing pointers to completed IP packets in the single IP packet buffer; and
wherein the ordering mechanism is configured to enter a pointer to a completed IP packet into the circular buffer upon completion of the IP packet.

15. The apparatus of claim 14, wherein the reading mechanism is configured to:
advance a buffer pointer around the circular buffer containing pointers to completed IP packets; and to
read the completed IP packets through pointers that are pointed to by the buffer pointer;
whereby the completed IP packets are read out of the single IP packet buffer in the order in which they were completed.

16. The apparatus of claim 13, wherein the single IP packet buffer is organized as a circular buffer, wherein buffers for incoming IP packets are appended to the end of the circular buffer.

17. The apparatus of claim 13, wherein the reassembly mechanism includes a write pointer into the single IP packet buffer for each stream of IP packets, wherein each write pointer points to a packet being reassembled for an associated stream of IP packets.

18. The apparatus of claim 17, wherein each write pointer includes:
a start pointer that points to the start of a packet being received for the associated stream within the single IP packet buffer;
a number of bytes received so far for the packet being received; and
logic that calculates the write pointer from the start pointer and the number of bytes received so far.

19. The apparatus of claim 13, wherein the reassembly mechanism is configured to:
receive a single transport packet that includes an end section of a first IP packet and a beginning section of a second IP packet;
direct the end section of the first IP packet to a first location in the single IP packet buffer where the first IP packet is being reassembled; and to
direct the beginning section of the second IP packet to a second location in the single IP packet buffer where the second IP packet is being reassembled.

20. The apparatus of claim 13, wherein the single stream of transport packets includes MPEG2 transport packets.

21. The apparatus of claim 13, wherein the reassembly mechanism includes a packet identifier (PID) filter that is configured to filter transport packets based upon packet identifiers (PIDs) in order to filter out transport packets containing data that is not of a specified type for the IP packets.

22. The apparatus of claim 13, wherein the reassembly mechanism includes a continuity checker that is configured to check continuity for transport packets to ensure that all transport packets that make up an IP packet are received in sequential order.

23. The apparatus of claim 13, further comprising, media access control (MAC) filter that is configured to filter IP packets based upon MAC addresses in order to filter out IP packets that are not directed to an IP destination address on a local network.

24. The apparatus of claim 13, wherein the single stream of transport packets is received from a satellite.
